(19) United States
(12) Patent Application Publication
(10) Pub. No.: US 2014/0253980 A1
(43) Pub. Date: Sep. 11, 2014

(54) SYSTEM, INFORMATION PROCESSING APPARATUS AND NON-TRANSITORY COMPUTER READABLE MEDIUM

(71) Applicant: Kentaro ARAI, Nagoya-shi (JP)

(72) Inventor: Kentaro ARAI, Nagoya-shi (JP)

(73) Assignee: BROTHER KOGYO KABUSHIKI KAISHA, Nagoya-shi (JP)

(21) Appl. No.: 14/202,884

(22) Filed: Mar. 10, 2014

(30) Foreign Application Priority Data
Mar. 11, 2013 (JP) 2013-047546

(51) Int. Cl. H04N 1/23

(52) U.S. Cl. CPC H04N 1/2307
USPC 358/474

(57) ABSTRACT

Computer readable instructions, when executed by a processor, may cause an information processing apparatus to determine whether one or more of status information including specific apparatus identification information are received during a first time period around the time of receiving a reading instruction. The computer readable instructions, when executed by the processor, may cause the information processing apparatus to determine whether one or more of specific image reading apparatuses identified by one or more of specific apparatus identification information can execute a reading operation represented by acquired setting information from a memory, using one or more of a plurality of function information associated with the one or more of specific apparatus identification information, and transmit a determination result to an operation apparatus based on determining whether the one or more of specific image reading apparatuses can execute the reading operation.

### CROSS REFERENCE TO RELATED APPLICATION

This application is based upon and claims the benefit of priority of Japanese Patent Application No. 2013-047546 filed on Mar. 11, 2013, the contents of which are incorporated herein by reference in its entirety.

### BACKGROUND

The disclosure relates to an information processing apparatus enabling an apparatus, which provides a service useable on a Web page, to acquire data and a network system.

In recent years, a variety of data for various services useable on a Web page can be uploaded. For example, in a related read image transfer system, an image transfer apparatus connected to an image reading apparatus and a web log server are connected through a network. The image transfer apparatus controls the image reading apparatus to thus read out image information from a document and transfers the read image information to the web log server. The web log server provides a web log site in which an image based on the transferred image information is posted.

### SUMMARY

Regarding a technology of uploading various data, a following example is considered. That is, a service providing apparatus provides a Web page on which an icon is displayed. When the icon is operated, the image information read out by the image reading apparatus is automatically uploaded to a web site that is provided by the service providing apparatus. In this example, it is necessary for a user to find out an image reading apparatus that can execute a reading operation in a specification demanded by the service providing apparatus, depending on the specification that is demanded by the service providing apparatus. However, the specification that is demanded by the service providing apparatus has not been considered. For this reason, it takes time for the user to find out an image reading apparatus that can execute a reading operation in a specification demanded by the service providing apparatus.

An object of the disclosure is to provide an information processing apparatus with which a user can easily find out a scanner apparatus capable of executing a reading operation by a reading setting corresponding to a specification that is demanded by the service providing apparatus, and a network system.

A system comprising:

an information processing apparatus; and

an image reading apparatus,

wherein the information processing apparatus comprises:

a first processor; and

first memory storing computer readable instructions, when executed by the first processing, cause the information processing apparatus to:

store, in a memory:
service identification information for identifying a service providing apparatus;
setting information representing a specification of a reading setting of an image reading apparatus for the service providing apparatus, in association with the service identification information;
user identification information;
a plurality of apparatus identification information for identifying a plurality of image reading apparatuses in association with the user identification information; and
a plurality of function information in association with each of the plurality of apparatus identification information, each of the plurality of the function information representing a function represents each of the image reading apparatuses can execute the reading operation;

receive, from an operation apparatus, a reading instruction for instructing an image reading apparatus to execute a reading operation, specific service identification information, and specific user identification information;

acquire the setting information associated with the specific service identification information from the memory;

determine whether one or more of status information including specific apparatus identification information are received during a first time period around the time of receiving the reading instruction;

store, in a memory, the one or more of specific apparatus identification information, in response to determining that one or more of status information are received during the first time period;

determine whether one or more of specific image reading apparatuses identified by the one or more of specific apparatus identification information can execute the reading operation represented by the acquired setting information, using one or more of the plurality of function information associated with the one or more of specific apparatus identification information; and

transmit a determination result to the operation apparatus based on determining whether the one or more of specific image reading apparatuses can execute the reading operation, and

wherein the image reading apparatus comprises:

a second processor; and

second memory storing computer readable instructions, when executed by the second processor, cause the image reading apparatus to:

determine whether a reading target is placed on the image reading apparatuses; and

transmit the status information to the information processing apparatus.

An information processing apparatus comprising:

a processor; and

memory storing computer readable instructions, when executed by the processor, cause the information processing apparatus to:

store, in a memory:
service identification information for identifying a service providing apparatus;
setting information representing a specification of a reading setting of an image reading apparatus for the service providing apparatus, in association with the service identification information;
user identification information;
a plurality of apparatus identification information for identifying a plurality of image reading apparatuses in association with the user identification information; and
a plurality of function information in association with each of the plurality of apparatus identification information, each of the plurality of the function information representing a function represents each of the image reading apparatuses can execute the reading operation;

receive, from an operation apparatus, a reading instruction for instructing an image reading apparatus to execute a reading operation, specific service identification information, and specific user identification information;

acquire the setting information associated with the specific service identification information from the memory;

determine whether one or more of status information including specific apparatus identification information are received during a first time period around the time of receiving the reading instruction, the status information representing a reading target is placed on an image reading apparatuses identified the specific apparatus identification information;

store, in a memory, the one or more of specific apparatus identification information, in response to determining that one or more of status information are received during the first time period;

determine whether one or more of specific image reading apparatuses identified by the one or more of specific apparatus identification information can execute the reading operation represented by the acquired setting information, using one or more of the plurality of function information associated with the one or more of specific apparatus identification information; and

transmit a determination result to the operation apparatus based on determining whether the one or more of specific image reading apparatuses can execute the reading operation.

A non-transitory computer-readable medium storing computer-readable instructions that, when executed by a processor, cause an information processing apparatus to:

store, in a memory:
service identification information for identifying a service providing apparatus;
setting information representing a specification of a reading setting of an image reading apparatus for the service providing apparatus, in association with the service identification information;
user identification information;
a plurality of apparatus identification information for identifying a plurality of image reading apparatuses in association with the user identification information; and
a plurality of function information in association with each of the plurality of apparatus identification information, each of the plurality of the function information representing a function represents each of the image reading apparatuses can execute the reading operation;

receive, from an operation apparatus, a reading instruction for instructing an image reading apparatus to execute a reading operation, specific service identification information, and specific user identification information;

acquire the setting information associated with the specific service identification information from the memory;

determine whether one or more of status information including specific apparatus identification information are received during a first time period around the time of receiving the reading instruction, the status information representing a reading target is placed on an image reading apparatuses identified the specific apparatus identification information;

store, in a memory, the one or more of specific apparatus identification information, in response to determining that one or more of status information are received during the first time period;

determine whether one or more of specific image reading apparatuses identified by the one or more of specific apparatus identification information can execute the reading operation represented by the acquired setting information, using one or more of the plurality of function information associated with the one or more of specific apparatus identification information;

transmit a determination result to the operation apparatus based on determining whether the one or more of specific image reading apparatuses can execute the reading operation.

### BRIEF DESCRIPTION OF DRAWINGS

FIG. 1 is an example of a schematic configuration view of a network system 1.

FIG. 2 illustrates an example of a processing operation of the network system 1.

FIG. 3 shows an example of a Web page 91.

FIG. 4 shows an example of an electrical configuration of a central server 2.

FIG. 5 shows an example of an electrical configuration of a scanner apparatus 7.

FIG. 6 is an example of a data configuration view of a scanner data table 82.

FIG. 7 is an example of a data configuration view of a scanner function data table 83.

FIG. 8 is an example of a data configuration view of a service management data table 84.

FIG. 9 is an example of an illustration showing a timeline of the processing.

FIG. 10 is an example of a flow chart of the main processing of the central server 2.

FIG. 11 is an example of a flow chart of the main processing to the central server 2.

FIG. 12 is an example of a flow chart of main processing of the scanner apparatus 7.

### DESCRIPTION OF EXEMPLARY EMBODIMENTS

### 1. Outline of Configuration of Network System 1

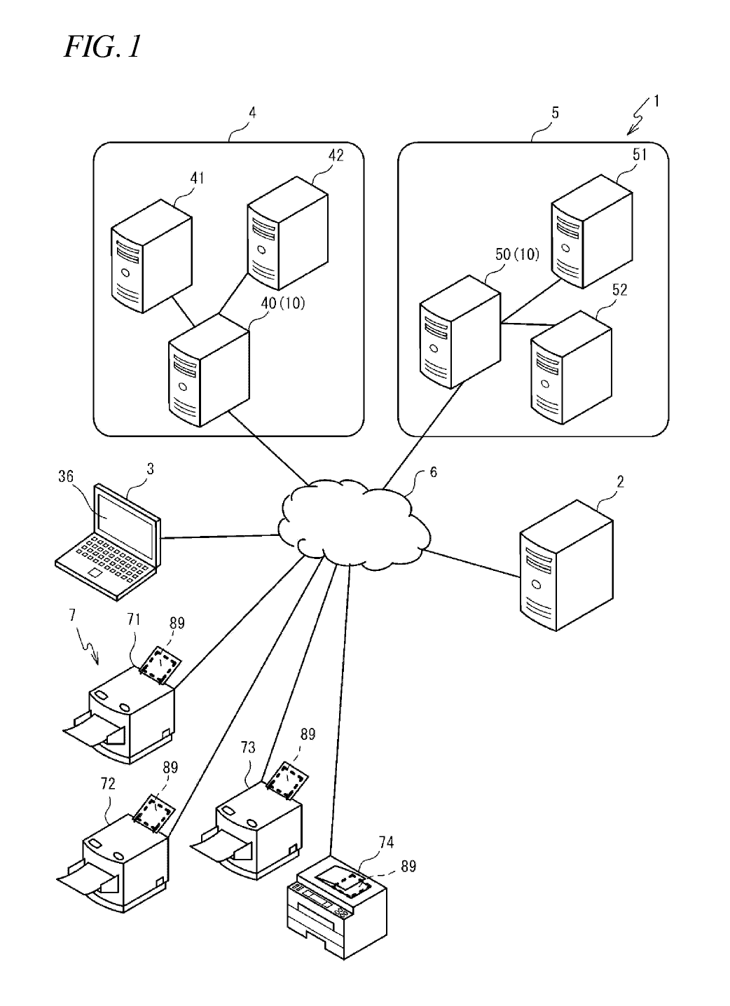

An illustrative embodiment of the disclosure will be described with reference to the drawings. A configuration of a network system 1 of this illustrative embodiment is described with reference to FIG. 1. As shown in FIG. 1, the network system 1 includes a central server 2, an operation apparatus 3, scanner apparatuses 71, 72, 73, 74 and network services 4, 5. The scanner apparatuses 71, 72, 73, 74 may be reading apparatuses that can read an image. For example, the scanner apparatus may be a printing apparatus having a scanner function. In the example shown in FIG. 1, a document 89 that is a reading target is placed on the scanner apparatus 72. In the meantime, the central server 2 is an example of the information processing apparatus of the disclosure. The scanner apparatuses 71, 72, 73, 74 are examples of the image reading apparatus of the disclosure. In addition to the scanner apparatuses 71, 72, 73, 74, a scanner apparatus is connected to a network 6. In the below descriptions, when collectively mentioning the scanner apparatuses 71, 72, 73, 74 and the scanner apparatus (not shown) or not specifying any one, it may be referred to as a scanner apparatus 7.

The network service 4 includes an external server 40. The network service 5 includes an external server 50. The external server 40 provides the network service 4 of a company that is different from a manufacturer of the scanner apparatus 7.

The external server 50 provides the network service 5 of a company that is different from the manufacturer of the scanner apparatus 7 and is also different from the company of the external server 40. In other words, the external server 40 and the external server 50 are server apparatuses that are managed by the companies providing the service through the network 6. The external server 40 and the external server 50 are Web servers that are used so as to provide a service, for example. An external server (not shown) is also connected to the network 6, in addition to the external servers 40, 50. In the below descriptions, when collectively mentioning the external servers 40, 50 and the external server (not shown) or not specifying any one, it may be referred to as an external server 10.

The network service 4 includes a storage server 41 and a storage server 42. The network service 5 includes a storage server 51 and a storage server 52. At least one storage server may be provided for each network service. Instead of the storage server, the external server 40 or external server 50 may have a storage area of data that is used in the network service. In this case, the storage servers are not required. The external server 40, the external server 50 and the storage servers 41, 42, 51, 52 provide a service that can be used on a Web page. The external server 40, the external server 50, the storage server 41, the storage server 42, the storage server 51 and the storage server 52 are examples of the service providing apparatus of the disclosure.

The operation apparatus 3 uses the services that are provided by the network service 4 and the network service 5. Specifically, the operation apparatus 3 acquires a Web page from the external server 40 or external server 50 and uses the network service 4 and the network service 5. The operation apparatus 3 uses data that is stored in the storage servers 41, 42, 51, 52.

The operation apparatus 3 may be a general PC. The operation apparatus 3 may be a portable terminal apparatus such as a smart phone. The operation apparatus 3 may be an apparatus that can perform information processing. In the meantime, the central server 2, the scanner apparatus 7, the operation apparatus 3, the external server 40 and the external server 50, which are shown in FIG. 1, can perform communication with each other through the network 6. The scanner apparatus 7 may be connected to the network 6 through a relay apparatus such as a PC (not shown).

### 2. Outline of Operations of Network System 1

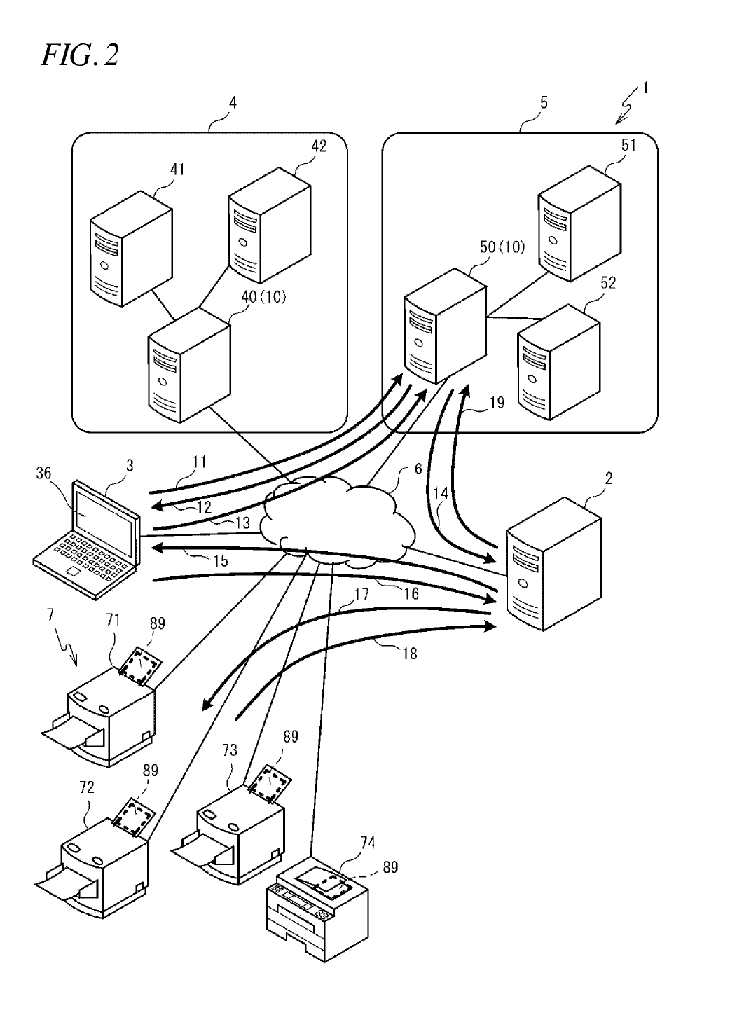

Operations of the network system 1 are described with reference to FIG. 2. In the below descriptions, it is assumed that the network service 5 provides a document service. A user of the operation apparatus 3 posts a document to the document service. In this illustrative embodiment, the document is the document 89. The document service is a service enabling the document, which is posted by the user, to be used through the network service 5.

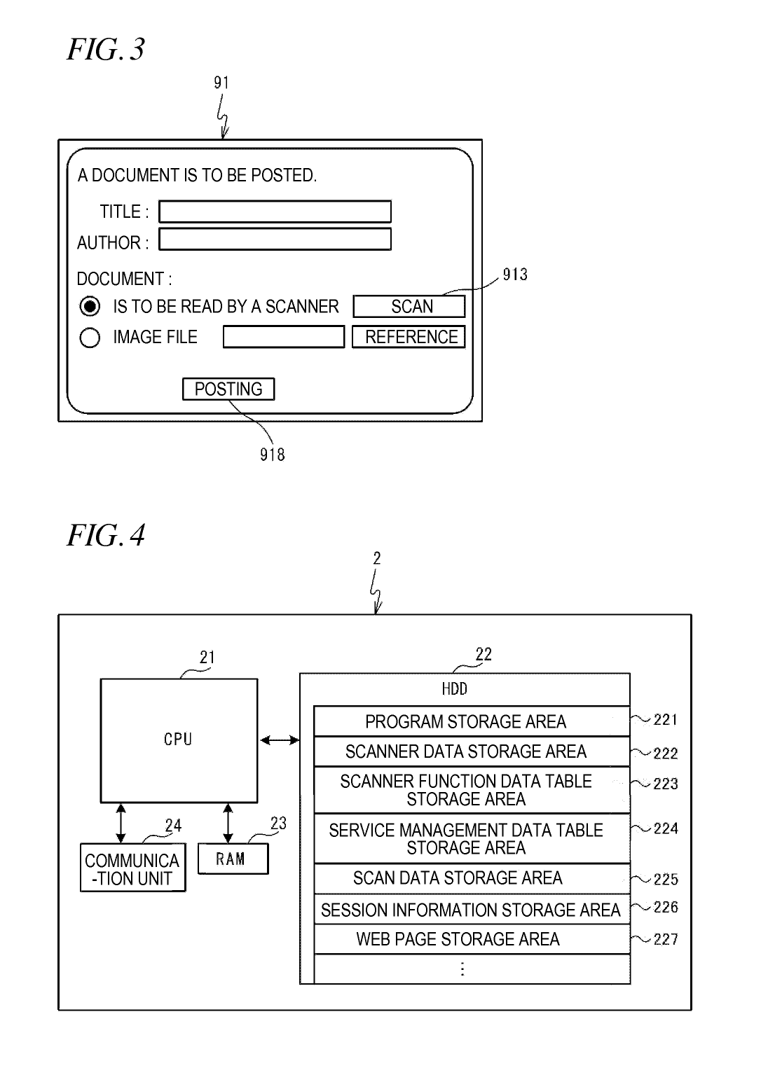

First, as shown with an arrow 11 of FIG. 2, the operation apparatus 3 accesses the external server 50. At this time, the operation apparatus 3 requests the external server 50 to transmit a Web page. Then, as shown with an arrow 12, the operation apparatus 3 acquires a Web page 91 shown in FIG. 3 from the external server 50. The acquired Web page 91 is displayed on a display unit 36 that is controlled by the operation apparatus 3. In the meantime, it is necessary to execute login processing so as to use the network service 5.

The user can select a case where the scanner apparatus 7 reads the document 89 and to post image data of the document and a case where an image file stored in an HDD of the operation apparatus 3 is posted. When posting the image file, the user operates the Web page 91 by using the operation apparatus 3, selects the image file and operates a posting button 918. When the posting button 918 is operated, the selected image file is transmitted to the external server 50. The external server 50 makes a document based on the image file available (usable) through the network service 5.

When enabling the scanner apparatus 7 to read the document 89 and to post image data of the document, the user operates a scan execution button displayed on the operation apparatus 3 by using the operation apparatus 3. For example, the user operates a scan execution button 913 of the Web page 91 (refer to FIG. 3). The scan execution button 913 is an example of the operation information of the disclosure.

In this illustrative embodiment, when the scan execution button is executed, information indicating that the scan execution button is operated, a user ID and the like are transmitted to the external server 50, as shown with an arrow 13 of FIG. 2. The user ID represents information for identifying a user who operates the operation apparatus 3. The external server 50 specifies an access token corresponding to the received user ID. The access token represents information indicating whether the user who is using the network service 4 or network service 5 has an authority to use the central server 2. The access token is also information for identifying the user who operates the operation apparatus 3.

Then, as shown with an arrow 14, a reading instruction, service identification information (which will be described later), the access token, and the like are transmitted from the external server 50 to the central server 2. That is, as the scan execution button is operated by the operation apparatus 3, the central server 2 receives the reading instruction. The reading instruction represents information of an instruction that causes the scanner apparatus 7, which can be used by the operation apparatus 3, to execute a reading operation as the scan execution button is operated. In the meantime, the login processing for accessing the central server 2 may be executed by the operation apparatus 3 before the operation instruction is transmitted to the central server 2.

The central server 2 having received the operation instruction prepares a Web page on which setting information relating to the service of the external server 50 and scanner information of the scanner apparatus 7 on which the document 89 is placed are displayed. The setting information represents information of a reading setting corresponding to a specification that is demanded by the external server 10. The scanner information represents information for identifying the scanner apparatus 7. The different scanner information is assigned to each of the plurality of scanner apparatuses 7. In the meantime, the scanner information is an example of the apparatus identification information of the disclosure.

As shown with an arrow 15 of FIG. 2, the prepared Web page is transmitted to the operation apparatus 3 and is displayed on the display unit 36. The operation apparatus 3 determines scanner information of the scanner apparatus 7, which executes the reading operation, and setting information, in response to an operation of the user. The operation apparatus 3 operates the scan execution button of the Web page, in response to an operation of the user. When the scan execution button is operated, the determined scanner information and setting information are transmitted to the central server 2, as shown with an arrow 16.

As shown with an arrow 17, the central server 2 transmits the determined setting information to the scanner apparatus 7 corresponding to the determined scanner information. The scanner apparatus 7 performs a reading operation of the document 89 with a reading setting corresponding to the determined setting information, thereby preparing image data. As shown with an arrow 18, the scanner apparatus 7 uploads the image data to the central server 2. As shown with an arrow 19, the external server 50 downloads the image data from the central server 2. Thereby, the image data of the document 89 read in the scanner apparatus 7 is acquired by the external server 50. That is, the image data can be used through the network service 5.

In the meantime, when a storage server is provided for the network service 5, the external server 50 may transmit the image data downloaded from the central server 2 to the storage server 51 or storage server 52. The storage server 52 may download the image data from the central server 2. The downloaded image data is stored in a predetermined storage area that can be accessed using a user ID logged in the network service 5.

Although not shown, the operation apparatus 3 requests the image data, which can be used through the network service 5, from the external server 50 through a Web browser of the operation apparatus 3, for example. When the request for the image data is received, the external server 50 transmits a Web page. The transmitted Web page causes the operation apparatus 3 to access the image data stored in the external server 50, the storage server 51 or the storage server 52. Then, the operation apparatus 3, which is a source of the request, downloads the image data from the external server 50, the storage server 51 or the storage server 52 that stores the requested image data.

### 3. Electrical Configuration of Central Server 2

An electrical configuration of the central server 2 of this illustrative embodiment is described with reference to FIG. 4. The central server 2 has a CPU 21, an HDD 22, a RAM 23 and a communication unit 24. The HDD 22, the RAM 23 and the communication unit 24 are electrically connected to the CPU 21, respectively. The CPU 21 functions as a computer that controls the central server 2. The CPU acquires a time according to a program stored in the HDD 22. The CPU 21 is an example of a processor.

The HDD 22 includes a program storage area 221, a scanner data table storage area 222, a scanner function data table storage area 223, a service management data table storage area 224, a scan data storage area 225, a session information storage area 226 and a Web page storage area 227.

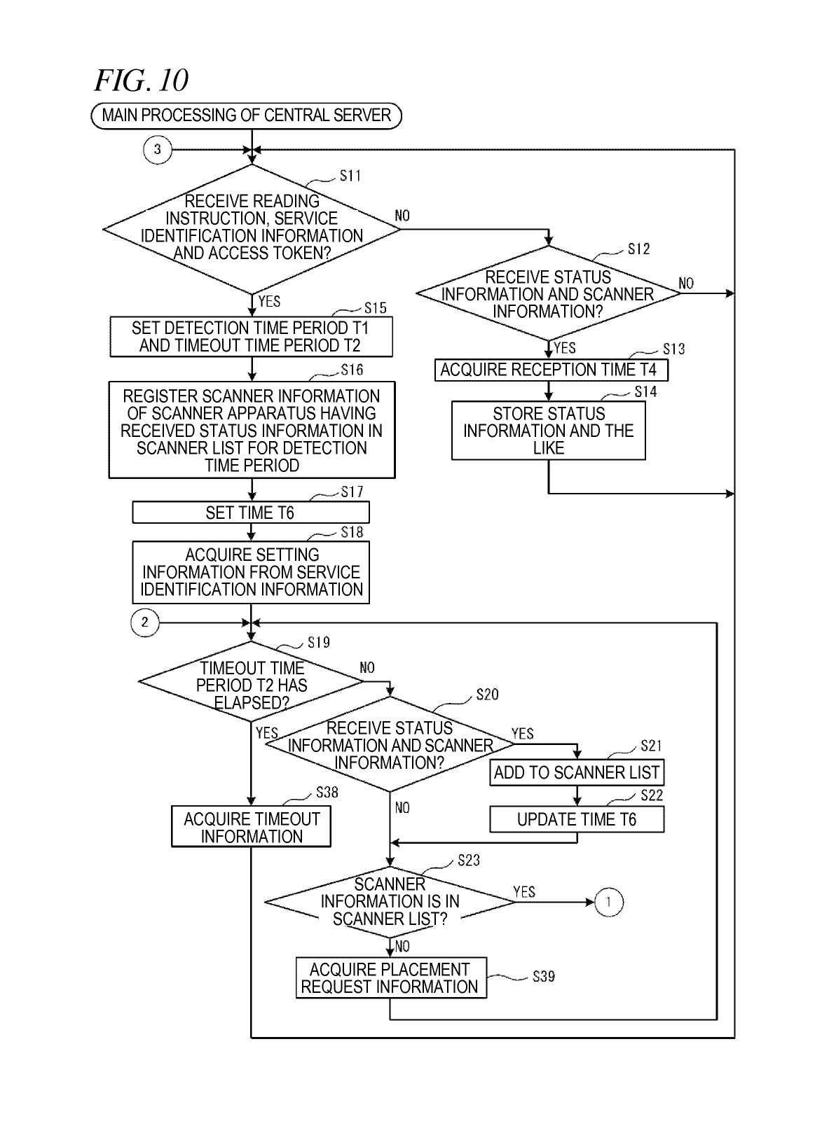

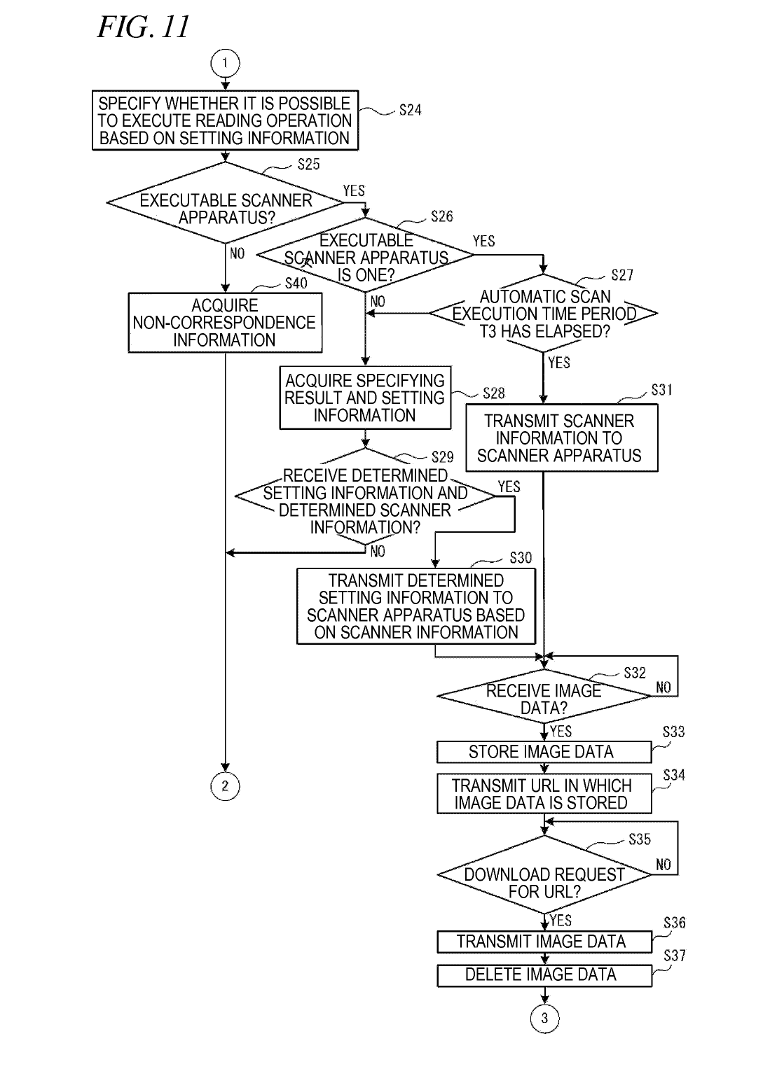

The program storage area 221 stores a program of main processing of the central server 2, which is shown in FIGS. 10 and 11, and the like. In the meantime, the program may be downloaded from a predetermined server on the network 6, for example. The program may be recorded in a recording medium such as a CD-ROM and the like and may be read and input through a drive.

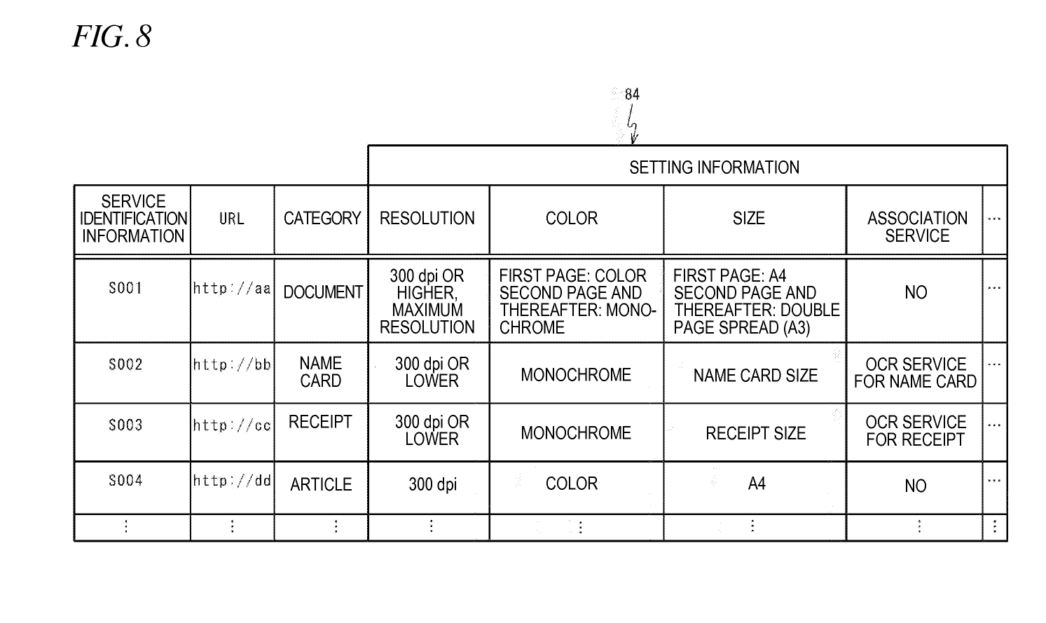

The scanner data table storage area 222 stores a scanner data table 82 (which will be described later) shown in FIG. 6. The scanner function data table storage area 223 stores a scanner function data table 83 (which will be described later) shown in FIG. 7. The service management data table storage area 224 stores a service management data table 84 (which will be described later) shown in FIG. 8. The scan data storage area 225 stores the image data read by the scanner apparatus 7.

The session information storage area 226 stores session information. Specifically, the session information represents information about a session of the central server 2 and the scanner apparatus 7. The session information may be information about a session of an apparatus, which can be connected to the network 6 in addition to the scanner apparatus 7, and the central server 2. The central server 2 stores the session information about the scanner apparatus 7, so that the central server 2 can transmit a reading instruction to the scanner apparatus 7. The session information is stored, so that the information can be transmitted and received between the central server 2 and the scanner apparatus 7.

The RAM 23 temporarily stores information that is temporarily used by the central server 2. The communication unit 24 is connected to the network 6 of FIG. 1. The CPU 21 performs communication with the operation apparatus 3, the network service 4, the network service 5 and the scanner apparatus 7 through the communication unit 24 and the network 6.

### 4. Electrical Configuration of Scanner Apparatus 7

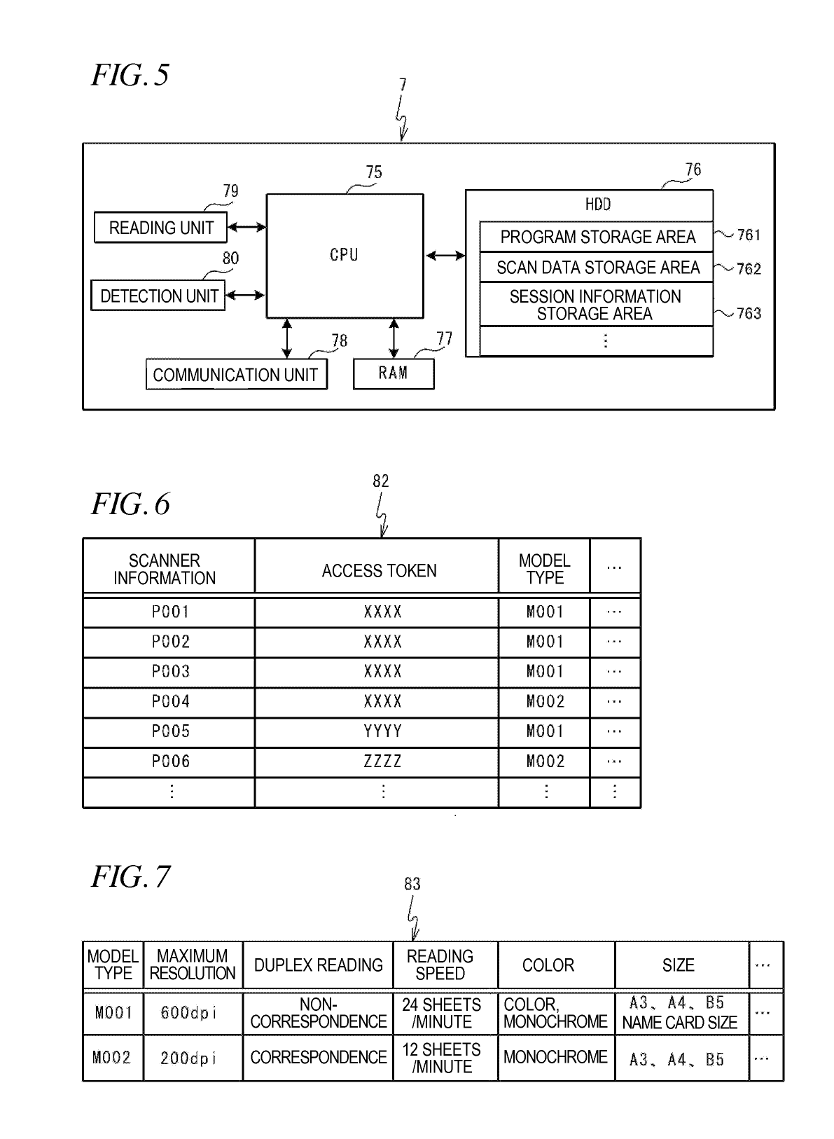

An electrical configuration of the scanner apparatus 7 is described with reference to FIG. 5. The scanner apparatus 7 has a CPU 75, an HDD 76, a RAM 77, a communication unit 78, a reading unit 79 and a detection unit 80. The HDD 76, the RAM 77, the communication unit 78, the reading unit 79 and the detection unit 80 are electrically connected to the CPU 75, respectively. The CPU 75 functions as a computer that controls the scanner apparatus 7.

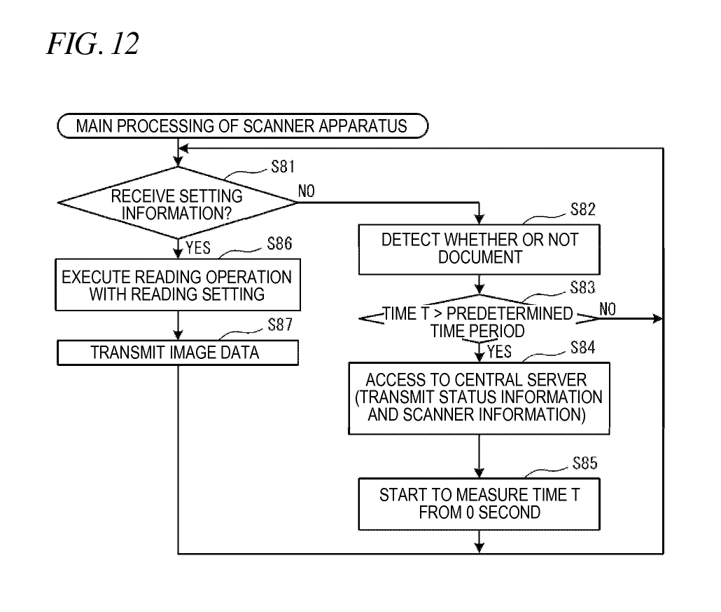

The HDD 76 includes a program storage area 761, a scan data storage area 762 and a session information storage area 763. The program storage area 761 stores a program of main processing of the scanner apparatus 7, which is shown in FIG. 12, and the like. The program may be downloaded from a predetermined server on the network 6, for example. The program may be recorded in a recording medium such as a CD-ROM and the like and may be read and input through a drive. The scan data storage area 762 stores image data that is read by the reading unit 79.

The session information storage area 763 stores session information. In this illustrative embodiment, the scanner apparatus 71 or central server 2 periodically checks a session, so that the session information is stored in the session information storage area 763. The scanner apparatus 7 stores the session information, so that the scanner apparatus 7 can receive a variety of information transmitted from the central server 2.

The RAM 77 temporarily stores information that is temporarily used by the scanner apparatus 7. The communication unit 78 is connected to the network 6 of FIG. 1. The CPU 75 performs communication with the central server 2 through the communication unit 78 and the network 6.

The reading unit 79 has a configuration for reading the document 89 set on the scanner apparatus 7. Specifically, the reading unit 79 has a conveyance roller, an image reading sensor and the like. The image reading sensor is an imaging device such as a CIS (Contact Image Sensor), a CCD (Charge Coupled Sensor) and the like. The reading unit 79 having a function of reading the image data is driven, so that the image data is acquired from the document 89. The detection unit 80 detects whether the document 89 is placed on the scanner apparatus 7. The detection unit 80 may detect whether the document 89 is placed on an ADF (Auto Document Feeder) (not shown), for example. The detection unit 80 may detect whether a cover (for example, a unit of an openable/closable ADF) covering a reading face on which a document is placed and which is provided above the image reading unit is opened or closed and may detect whether or not the document 89.

The scanner data table 82 is described with reference to FIG. 6. In the scanner data table 82, at least the scanner information, the access token and a model type are registered in the scanner data table 82. The scanner information, the access token and a model type are associated in the scanner data table 82. Specifically, ‘P001’, ‘XXXX’, and ‘M001’ are associated in order of the scanner information, the access token and the model type. In addition, the association as shown in FIG. 6 is made.

As described above, the scanner information represents information for identifying the scanner apparatus 7. In this illustrative embodiment, the scanner information of the scanner apparatus 71 is referred to as ‘P001’. The scanner information of the scanner apparatus 72 is referred to as ‘P002’. The scanner information of the scanner apparatus 73 is referred to as ‘P003’. The scanner information of the scanner apparatus 74 is referred to as ‘P004’. The scanner information of a scanner apparatus (not shown) is referred to as ‘P005’ and ‘P006’. The scanner information ‘P001’, ‘P002’, ‘P003’ and ‘P004’ are associated with the access token ‘XXXX’. That is, the scanner apparatuses 71, 72, 73, 74 are the scanner apparatus 7 that is possessed by the user of the operation apparatus 3.

The model type represents information indicating a model type of the scanner apparatus 7. In this illustrative embodiment, the model type associated with the scanner information ‘P001’, ‘P002’, ‘P003’ and ‘P005’ is ‘M001’. The model type associated with the scanner information ‘P004’ and ‘P006’ is ‘M002’.

The scanner function data table 83 is described with reference to FIG. 7. In the scanner function data table 83, function information representing one or more of functions relating to the model type of the scanner apparatus 7 is registered. In the scanner function data table 83, the function information represents at least a maximum resolution, a duplex reading, a reading speed, a color and a size. The maximum resolution, the duplex reading, the reading speed, the color and the size are associated in the scanner function data table 83 as the function information. Specifically, ‘M001’, ‘600 dpi’, ‘non-correspondence’, ‘24 sheets/minute’, ‘color, monochrome’ and ‘A3, A4, B5, name card size’ are associated in order of the model type, the maximum resolution, the duplex reading, the reading speed, the color and the size. Likewise, ‘M002’, ‘200 dpi’, ‘correspondence’, ‘12 sheets/minute’, ‘monochrome’ and ‘A3, A4, B5’ are associated.

The maximum resolution is a maximum resolution when the scanner apparatus 7 prepares image data. The duplex reading represents information indicating whether the reading corresponds or does not correspond to a duplex reading. The reading speed represents information of a reading speed when the scanner apparatus 7 reads the document 89. The color is a color when the scanner apparatus 7 prepares image data. When the color is ‘color’, the scanner apparatus 7 can prepare image data of a color image. When the color is ‘monochrome’, the scanner apparatus 7 can prepare image data of a monochrome image. The size is a size of an image that can be prepared by the scanner apparatus 7.

The service management data table 84 is described with reference to FIG. 8. In the service management data table 84, the service identification information, a URL (Uniform Resource Locator), a category and the setting information are registered in the service management data table 84. The service identification information, the URL, the category and the setting information are associated in the service management table 84. The setting information includes a resolution, a color, a size and an association service. Specifically, ‘S001’, ‘http://aa’, ‘document’, ‘300 dpi or higher, maximum resolution’, ‘first page: color, second page and thereafter: monochrome’, ‘first page: A4, second page and thereafter: double page spread (A3)’, and ‘no’ are associated. In addition, the association as shown in FIG. 8 is made.

The service identification information represents information for identifying a service that is provided by the external server 10. In this illustrative embodiment, the service identification information of a document service that is provided by the external server 50 is referred to as ‘S001’. The service identification information of a name card management service that is provided by the external server 40 is referred to as ‘S002’. The service identification information of a service that is provided by the other external server is referred to as ‘S003’, ‘S004’ and the like. In the meantime, the external server 10 provides the operation apparatus 3 with a Web page on which the scan execution button is displayed. For example, the external server 50 provides the operation apparatus 3 with the Web page 91 on which the scan execution button 913 shown in FIG. 3 is displayed. When the scan execution button 913 is operated, the service identification information is transmitted to the central server 2 from the external server 50 and is received at the central server 2 (refer to an arrow 14 of FIG. 2). For this reason, the service identification information is also information indicating a provision source of the Web page on which the scan execution button 913 is displayed.

The URL represents information indicating locations of the external servers 40, 50 and the like on the network. Instead of the URL, an IP address may be registered. The category represents information indicating a type of a service that is provided by the external servers 40, 50 and the like. In the meantime, a ‘receipt’ is a service of reading information of a receipt and reflecting the same on a household account, for example. An ‘article’ is an article posting service.

The setting information registered in the service management data table 84 represents information of a reading setting corresponding to a specification that is demanded by the external server 10. The reading setting is set with a specification that is demanded by the external server 10 corresponding to the service identification information. The resolution is a resolution that is demanded when the scanner apparatus 7 prepares image data. For example, the resolution ‘300 dpi or higher and maximum resolution’ indicates that the image data is prepared with a resolution of 300 dpi or higher and maximum resolution that can be read by the scanner apparatus 7. The color indicates a setting of a color that is demanded when the scanner apparatus 7 prepares image data. For example, the color ‘first page: color, second page and thereafter: monochrome’ indicates that a first page is prepared with image data of a color image and a second page and thereafter are prepared with image data of a monochrome image. The size indicates a size that is demanded when the scanner apparatus 7 prepares image data. For example, the size ‘first page: A4, second page and thereafter: double page spread (A3)’ indicates that a first page is prepared with image data of an A4 size and a second page and thereafter are prepared with image data of an A3 size by a double page spread. In the meantime, when an A4 size is arranged with the double page spread, it becomes an A3 size.

The association service indicates that the external server 10 demands data after it performs a variety of processing in association with other services (not shown). For example, when the association service is ‘OCR service for a name card’, the image data read by the scanner apparatus 7 is transmitted from the central server 2 to a server (not shown) that provides an OCR service for a name card. In the server, text data is extracted from the image data by an OCR (Optical Character Reader). The extracted text data is transmitted from the server to the central server 2. The central server 2 transmits the text data to the external server 40 that provides a name card management service. Although not shown in main processing of the central server 2 shown in FIGS. 10 and 11, the scanner apparatus 7 may process the image data by using the association service as described above and cause the external server 10 to acquire the same.

### [5. Various Time Periods]

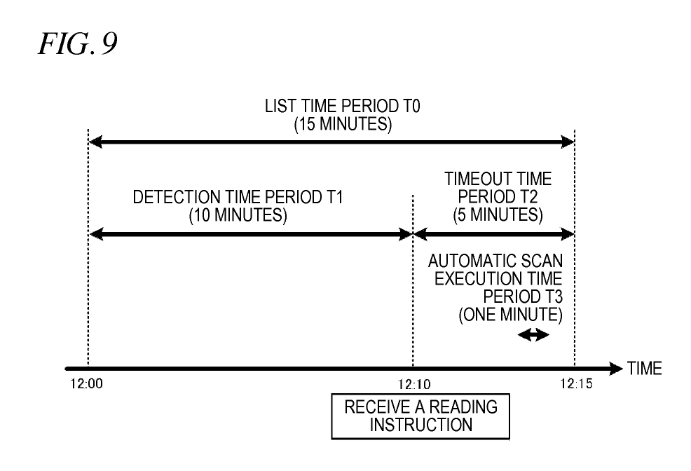

The list time period T0, the detection time period T1, the timeout time period T2 and the automatic scan execution time period T3 of this illustrative embodiment are described with reference to FIG. 9. As shown with an arrow 13 and an arrow 14 of FIG. 2, when the operation apparatus 3 operates the scan execution button, in response to a user's operation, a reading instruction is transmitted from the external server 10 to the central server 2. The reading instruction is received by the CPU 21 of the central server 2 in step S11 of FIG. 10, which will be described later. Meanwhile, in FIG. 9, the reading instruction is received at 12:10, for example, by the CPU 21. The detection time period T1 is a predetermined time period before the reading instruction is received by the CPU 21. The detection time period T1 is 10 minutes, for example. The detection time period T1 is stored in the HDD 22.

The timeout time period T2 is a predetermined time period after the reading instruction is received by the CPU 21. The timeout time period T2 is a time period for invalidating the reading instruction when the timeout time period T2 elapses after the CPU 21 receives the reading instruction. In the meantime, the timeout time period T2 may be beforehand stored in the HDD 22 or may be designated by the external server 10. The timeout time period T2 is 5 minutes, for example. The list time period T0 is a predetermined time period around the time of the reading instruction being received by the CPU 21. In this illustrative embodiment, the list time period T0 is a summed time period of the detection time period T1 and the timeout time period T2. In the meantime, the list time period T0 is an example of the ‘first predetermined time period’ of the disclosure. The timeout time period T2 is an example of the ‘second predetermined time period’ of the disclosure.

For example, it is assumed that the user of the operation apparatus 3 posts the image data of the document 89 to the document service that is provided by the external server 50. In this case, for example, the user of the operation apparatus 3 places the document 89 on the scanner apparatus 7 and then operates the scan execution button. In this case, there is a high possibility that the document 89 will be placed on the scanner apparatus 7 for the detection time period T1. For example, after the user of the operation apparatus 3 operates the scan execution button, the user places the document 89 on the scanner apparatus 7. In this case, there is a high possibility that the document 89 will be placed on the scanner apparatus 7 for the timeout time period T2. That is, there is a high possibility that the document 89 will be placed on the scanner apparatus 7 for the list time period T0. For this reason, although specifically described, the central server 2 of this illustrative embodiment enables the operation apparatus 3 to acquire the scanner information of the scanner apparatus 7 on which the document 89 is placed in the list time period T0. The user of the operation apparatus 3 determines the scanner apparatus 7 that will be enabled to read the document 89 while referring to the scanner information acquired by the operation apparatus 3.

The automatic scan execution time period T3 is a time period for which execution of an automatic scan is delayed. The automatic scan is a function with which the CPU 21 of the central server 2 automatically enables the scanner apparatus 7 to execute the reading when the document 89 is placed on the scanner apparatus 7. In this illustrative embodiment, the automatic scan execution time period T3 is set as a predetermined time period after the reading instruction is received or after final status information is received for the timeout time period T2. The status information represents information indicating whether the document 89 is placed on the scanner apparatus 7, and is transmitted from the scanner apparatus 7. The automatic scan execution time period T3 is one minute, for example. The automatic scan execution time period T3 is stored in the HDD 22. Meanwhile, the automatic scan execution time period T3 is an example of the ‘third predetermined time period’ of the disclosure.

### [6. Operations of Central Server 2]

Main processing of the central server 2 is described with reference to FIGS. 10 and 11. The main processing of the central server 2 is executed by the CPU 21. The main processing of the central server 2 is executed when a power supply becomes on and is over when the power supply becomes off. In the below descriptions, each processing step is abbreviated to ‘S’. In the below descriptions, an example where a user operates the operation apparatus 3 to thus log in the external server 50 and to post the document 89 to the document service is described as a specific example.

First, it is determined whether the reading instruction, the service identification information and the access token are received (S11). The reading instruction, the service identification information and the access token are transmitted from the external server 10 as the scan execution button is operated by the operation apparatus 3 (the arrows 13 and 14 of FIG. 2). By the reading instruction, a scan instruction API (Application Program Interface) of the central server 2 is called, for example. The reading instruction may include a URL of the external server 10 to which the central server 2 notifies that reading of the image data by the scanner apparatus 7 is over. Instead of the URL of the external server 10, an IP address of the external server 10 may be included in the reading instruction.

Here, the access token that is transmitted from the external server 10 is described. The access token is issued by the CPU 21 of the central server 2. More specifically, for example, when the user operates the operation apparatus 3 to thus log in the external server 10 or when the scan execution button is operated, the external server 10 issues a request for delegation of authority, which enables the user of the operation apparatus 3 to use the central server 2, to the central server 2. When the request for delegation of authority is issued, the CPU 21 of the central server 2 receives login processing from the operation apparatus 3. The user operates the operation apparatus 3 to thus input a user ID and the like, thereby executing the login. When the login is executed from the operation apparatus 3, the CPU 21 issues an access token. The issued access token is transmitted to the external server 10 that is a source of the request. The external server 10 associates the transmitted access token and the user ID and stores the same in a predetermined storage area. The external server 10 specifies the stored access token from the user ID transmitted from the operation apparatus 3 and transmits the same to the central server 2. In S11, the access token transmitted from the external server 10, as described above, is received.

When issuing the access token, the CPU 21 associates the access token and the user ID and registers the same in an access token database (not shown) and stores the same in the HDD 22. The CPU 21 updates the scanner data table 82 shown in FIG. 6 so that the access token associated with the scanner information of the scanner apparatus 7 possessed by the user of the operation apparatus 3 becomes the issued access token. Meanwhile, in the scanner data table 82 shown in FIG. 6, the user ID other than the access token may be registered with being associated with the scanner information.

When the reading instruction, the service identification information and the access token are not received (S11: NO), it is determined whether the status information and the scanner information are received or not (S12). In the meantime, the scanner apparatus 7 accesses the central server 2 in S84 of FIG. 12 that will be described later. In S84, when the document 89 is placed on the scanner apparatus 7, the status information and the scanner information are transmitted to the central server 2. The transmitted status information is received in S12 or S20 (which will be described later). The status information represents information indicating that the document 89 is placed on the scanner apparatus 7. In the meantime, although not shown in FIG. 10, when the access from the scanner apparatus 7 is made, a session between the accessed scanner apparatus 7 and the central server 2 is maintained. Specifically, the session information is stored in the session information storage area 226.

As shown in FIG. 10, when it is determined that the status information and the scanner information are not received (S12: NO), the CPU 21 returns the processing to S11. When it is determined that the status information and the scanner information are received (S12: YES), time T4 is acquired (S13). The time T4 indicates time at which the status information is received in S12. Then, the scanner information indicating the scanner apparatus 7 having transmitted the status information, the access token and the time T4 are associated and stored in a document placement data table (not shown) and is stored in the RAM 23 (S14).

In the specific example, it is assumed that the document 89 is placed on the scanner apparatus 73. In this case, the status information and the scanner information ‘P001’ are transmitted to the central server 2 by the CPU of the scanner apparatus 73. It is assumed that the status information and the scanner information ‘P001’ are received at time ‘11:30’ in S12 (S12: YES). In this case, the time T4 ‘11:30’ is acquired (S13). In S14, first, the scanner data table 82 of FIG. 6 is referred to and the access token ‘XXXX’ corresponding to the scanner information ‘P001’ received in S12 is specified. Then, the scanner information ‘P001’, the access token ‘XXXX’ and the time T4 ‘11:30’ are associated and registered in the document placement data table and stored in the RAM 23. On the other hand, when a user ID other than the access token is registered in the scanner data table 82 of FIG. 6, for example, the user ID is stored in the document placement data table, instead of the access token. Then, the CPU 21 returns the processing to S11.

In the specific example, it is assumed that the status information and the scanner information ‘P002’ are received at time ‘12:05’ (S12: YES). In this case, the scanner information ‘P002’, the access token ‘XXXX’ and the time T4 ‘12:05’ are associated and registered in the document placement data table, in S13 and S14. The document placement data table is stored in the RAM 23. Likewise, it is assumed that the status information and the scanner information ‘P005’ are received at time ‘12:06’ (S12: YES). In this case, the scanner information ‘P005’, the access token ‘XXXX’ and the time T4 ‘12:06’ are associated and registered in the document placement data table, in S13 and S14.

When the reading instruction, the service identification information and the access token are received (S11: YES), the time is acquired and the detection time period T1 and the timeout time period T2 are set (S15). In the specific example, it is assumed that the time at which the reading instruction and the like are received in S11 is ‘12:10’. In this case, for example, as shown in FIG. 9, the detection time period T1 is 12:0012:10 and the timeout time period T2 is 12:1012:15. That is, the list time period T0 is 12:0012:15.

Then, for the detection time period T1, the scanner information, which indicates the scanner apparatus 7 having transmitted the status information received in S12, is registered in a scanner list (not shown) (S16). The scanner list is a data table of the scanner information of the scanner apparatus 7 on which the document 89 is placed. In the specific example, the document placement data table is referred to, so that the scanner information ‘P002’ corresponding to the access token ‘XXXX’ is specified from the scanner information in which ‘time’ is set in the detection time period T1 ‘12:0012:10’. Then, the specified scanner information ‘P002’ is registered in the scanner list. That is, the scanner information ‘P002’ of the scanner apparatus 73 on which the document 89 is placed before the detection time period T1 is not registered in the scanner list. This is because there is a high possibility that when the document 89 is placed before the detection time period T1, it is not the document 89 that the user operating the operation apparatus 3 intends to enable the scanner apparatus 7 to read. In the meantime, for example, when the user ID other than the access token is registered in the document placement data table, the CPU 21 refers to the access token database, thereby specifying the user ID associated with the access token received in S11. Then, in the document placement data table, the scanner information associated with the specified user ID is registered in the scanner list.

Then, time T6 is acquired and set (S17). The time T6 is stored in the RAM 23. In the meantime, the time T6 is updated in S22 (which will be described later) when the status information is received for the timeout time period T2. That is, the time T6 is set as time at which the reading instruction is received in S11 or time at which the final status information is received for the timeout time period T2.

Then, the setting information associated with the service identification information received in S11 is acquired from the service management data table 84 of FIG. 8 (S18). In the specific example, in the service management data table 84 of FIG. 8, the setting information associated with the service identification information ‘S001’ received in FIG. 8 is acquired. The acquired setting information includes the resolution ‘300 dpi or higher, maximum resolution’, the color ‘first page: color, second page and thereafter: monochrome’ and the size ‘first page: A4, second page and thereafter: double page spread (A3)’. In the meantime, since the association service is ‘no’, the reading setting of the association service is not acquired. The acquired setting information is stored in the RAM 23.

Then, it is determined whether the timeout time period T2 has elapsed or not (S19). When the timeout time period T2 has not elapsed (S19: NO), it is determined whether the status information and the scanner information are received or not (S20).

When the status information and the scanner information are not received (S20: NO), it is determined whether the scanner information is registered in the scanner list (S23). When the scanner information is registered (S23: YES), processing of S24 is executed, as shown in FIG. 11. In S24, it is specified whether the scanner apparatus 7 based on the scanner information of the scanner list can execute the reading operation represented by the setting information acquired in S18.

In the specific example, the scanner information ‘P002’ is registered in the scanner list. The CPU 21 refers to the scanner data table 82 of FIG. 6 to thus specify the model type ‘M001’ of the scanner information ‘P002’. The CPU 21 refers to the scanner function data table 83 of FIG. 7 to thereby specifies specific function information of the specified model type ‘M001’. For example, the CPU 21 determines that the scanner apparatus represented by the model type ‘M001’ can execute the reading operation represented by the setting information, using the specific function information. The maximum resolution, the color and the size of the model type ‘M001’ are ‘600 dpi’, ‘color, monochrome’ and ‘A3, A4, B5, name card size’, respectively. The setting information acquired in S18 includes the resolution ‘300 dpi or higher, maximum resolution’, the color ‘first page: color, second page and thereafter: monochrome’ and the size ‘first page: A4, second page and thereafter: double page spread (A3)’. For this reason, the model type ‘M001’ is the scanner apparatus 7 that can execute the reading operation represented by the setting information acquired in S18. Therefore, the scanner apparatus 72 based on the scanner information ‘P002’ is specified when it can execute the reading operation represented by the setting information acquired in S18. The specified result is stored in the RAM 23. In the meantime, the scanner apparatus 74 of the model type ‘M002’, which is based on the scanner information ‘P004’, cannot execute the reading operation represented by the setting information acquired in S18.

Then, it is determined whether there is the scanner apparatus 7 that is specified as a scanner apparatus capable of executing the reading operation by the processing of S24 (S25). When there is the scanner apparatus 7 that is specified as a scanner apparatus capable of executing the reading operation by the processing of S24 (S25: YES), it is determined whether the scanner apparatus 7 specified as a scanner apparatus capable of executing the reading operation by the processing of S24 is one or not (S26). When the scanner apparatus 7 specified as a scanner apparatus capable of executing the reading operation by the processing of S24 is one (S26: YES), it is determined whether the automatic scan execution time period T3 has elapsed or not (S27). In the meantime, the automatic scan execution time period T3 is a predetermined time period from the time T6 that is set in S17 or S22. That is, as described above, the automatic scan execution time period T3 is a predetermined time period after the reading instruction is received in S11 or after the final status information is received for the timeout time period T2 in S20.

When the automatic scan execution time period T3 has not elapsed (S27: NO), the CPU 21 enables the operation apparatus 3 to acquire the specifying result of S24 and the setting information acquired in S18 (S28, the arrow 15 of FIG. 2).

The processing of S28 is specifically described. In S28, a Web page including the specifying result of S24, the setting information acquired in S18 and the like is first prepared and is then stored in the Web page storage area 227. An example of the prepared Web page will be described later. Then, a URL indicating the Web page storage area 227 in which the Web page is stored is transmitted to the operation apparatus 3. The transmitted Web page is received by the operation apparatus 3. Then, when a request for a Web page for the transmitted URL is received, the Web page is transmitted to the operation apparatus 3. In the meantime, the request for a Web page is transmitted from the operation apparatus 3. The transmitted Web page is received and displayed by the operation apparatus 3.

An example of the Web page prepared in S28 is described. The Web page prepared in S28 is different depending on processing results of S26 and S27. In the specific example, the scanner information registered in the scanner list is ‘P002’. In this case, for example, a first Web page (not shown) is prepared. The first Web page has a scanner display area and a reading setting display area. In the scanner display area, an icon indicating the scanner information ‘P002’ registered in the scanner list is displayed. Hereinafter, the icon indicating the scanner information is referred to as a scanner apparatus icon.

In S24, it is specified that the scanner information ‘P002’ can execute the reading operation represented by the setting information acquired in S18. For this reason, the scanner apparatus icon is under a state where it can be selected by the operation apparatus 3, in response to a user's instruction. That is, the CPU 21 enables the operation apparatus 3 to acquire reading-possible apparatus information, which represents information indicating that the scanner apparatus 7 based on the scanner information registered in the scanner list is the scanner apparatus 7 capable of executing the reading operation acquired in S18 (S28). Thereby, the CPU 21 enables the operation apparatus 3 to acquire the specifying result of S24 (S28).

The information that is displayed in the reading setting display area is prepared on the basis of the setting information acquired in S18. In S18, the resolution ‘300 dpi or higher, maximum resolution’ is acquired. In the scanner function data table 83 of FIG. 7, the maximum resolution of the model type ‘M001’ of the scanner information ‘P001’ is ‘600 dpi’. Therefore, for example, the resolution ‘600 dpi’ is set and displayed in the reading setting display area. In the meantime, the operation apparatus 3 may change the resolution, in response to a user's operation. At this time, the resolution to be changed is limited to the resolution ‘300 dpi or higher’ acquired in S18.

In S18, the color ‘first page: color, second page and thereafter: monochrome’ and the size ‘first page: A4, second page and thereafter: double page spread (A3)’ are acquired. For this reason, a text of ‘first page: color A4’ and ‘second page and thereafter: monochrome A3 double page spread’ is displayed in the reading setting display area, for example. In the service management data table 84 of FIG. 8, the service identification information ‘S001’ is associated with the category ‘document’. For this reason, a text of ‘scan for a document’ is displayed in the reading setting display area, for example. The scan execution button is displayed in the reading setting display area. The operation apparatus 3 operates the scan execution button, in response to a user's operation.

The first Web page is prepared as described above. The first Web page includes the scanner information registered in the scanner list. The first Web page includes the reading-possible apparatus information. The first Web page includes the setting information acquired in S18. That is, the setting information of a specification that is demanded by the external server 50 is included. Like this, the CPU 21 prepares the first Web page and enables the operation apparatus 3 to acquire the same in S28, so that the scanner information on which the document 89 is placed, the reading-possible apparatus information and the setting information acquired in S18 are acquired.

After the processing of S28 is executed, it is determined whether the setting information and scanner information, which are determined on the basis of the setting information and scanner information acquired by the operation apparatus 3 in S28, are received (S29). That is, the setting information and scanner information, which are determined by the user of the operation apparatus 3 while referring to the Web page acquired by the operation apparatus 3 in S28, are received. In the below descriptions, the setting information, which is determined on the basis of the setting information acquired by the operation apparatus 3 in S28, is referred to as ‘determined setting information’. The scanner information, which is determined on the basis of the scanner information acquired by the operation apparatus 3 in S28, is referred to as ‘determined scanner information’. The determined setting information and determined scanner information are transmitted from the operation apparatus 3.

When the determined setting information and determined scanner information are not received (S29: NO), the CPU 21 returns the processing to S19 of FIG. 10. When the determined setting information and determined scanner information are received (S29: YES), the determined setting information is transmitted to the scanner apparatus 7 based on the determined scanner information (S30, an arrow 17 of FIG. 2). The transmitted determined setting information is received by processing of S81 of FIG. 12. The determined scanner information is referred to as ‘P002’. The determined setting information is referred to as the resolution ‘600 dpi’, the color ‘first page: color, second page and thereafter: monochrome’ and the size ‘first page: A4, second page and thereafter: double page spread (A3)’. In this case, the resolution ‘600 dpi’, the color ‘first page: color, second page and thereafter: monochrome’ and the size ‘first page: A4, second page and thereafter: double page spread (A3)’ are transmitted to the scanner apparatus 72 corresponding to the determined scanner information ‘P002’.

Then, it is determined whether the image data read by the scanner apparatus 7 is received, based on the determined setting information transmitted in S30 (S32). The image data is transmitted from the scanner apparatus 7 by processing of S87 of FIG. 12 (which will be described later) (an arrow 18 of FIG. 2). When the image data is not received (S32: NO), the CPU 21 repeats the processing of S32. When the image data is received (S32: YES), processing of S33 and S34 is executed and the image data can be acquired by the external server 10.

In S33, the received image data is stored in the scan data storage area 225. In S34, a URL of the scan data storage area 225 in which the image data is stored is transmitted to the external server 10. In the specific example, since the reading instruction and the like are transmitted from the external server 50 in S11, the URL is transmitted to the external server 50. The transmitted URL is received by the external server 50.

Then, it is determined whether a download request for the URL transmitted in S34 is received (S35). The download request is transmitted from the external server 50. When the download request is not received (S35: NO), the CPU 21 repeats the processing of S35. In the meantime, when a predetermined time period elapses after the processing of S35 is repeated, the processing of S35 may be over and the processing of S11 may be then executed.

When the download request is received (S35: YES), the image data is transmitted to the external server 10 that is a source of the request (S36, an arrow 19 of FIG. 2). The transmitted image data is received by the external server 10. Then, the image data stored in the scan data storage area 225 in S33 is deleted (S28). In the meantime, the image data may not be deleted. The case where the image data is deleted and the case where the image data is not deleted may be switched depending on the instruction of the external server 10. Then, the CPU 21 returns the processing to S11 of FIG. 11.

When the automatic scan execution time period T3 has elapsed at a state where the determined setting information and determined scanner information are not received in S29 and S30 (S27: YES), processing of S31 is executed. When the processing of S31 is executed, only one scanner information is registered in the scanner list. That is, the processing of S31 is executed when the one scanner apparatus 7 on which the document 89 is placed can execute the reading operation represented by the setting information specified in S18. In S31, the setting information acquired in S18 is transmitted to the one scanner apparatus 7 based on the scanner information registered in the scanner list. The transmitted setting information is received by processing of S81 of FIG. 12. Then, the CPU 21 proceeds to the processing of S32. That is, the CPU 21 enables the scanner apparatus 7 to acquire the image data, which is obtained by reading the document 89, with the reading setting based on the setting information acquired in S18 and transmits the same to the external server 10.

Like this, when the document 89 is placed on the one scanner apparatus 7 that can execute the reading operation by the reading setting corresponding to the specification demanded by the external server 10, the setting information acquired in S18 is automatically transmitted to the scanner apparatus 7. For this reason, the user can enable the scanner apparatus 7 to automatically execute the reading operation just by placing the document 89 on the scanner apparatus 7. Therefore, the user convenience is improved.

In S20, when the status information and scanner information are received (S20: YES), the scanner information indicating the scanner apparatus 7 having transmitted the status information is registered in the scanner list (S21). In the specific example, when the document 89 is placed on the scanner apparatus 73, the status information and the scanner information ‘P003’ are received (S20: YES). Then, although not shown, the scanner information ‘P003’ is added to the scanner list.

Then, the time T6 is updated (S22). Thereby, the time T6 is set as time at which the status information is acquired in S20. Then, the CPU 21 proceeds to processing of S23. In this case, in S24, it is specified that the scanner apparatuses 72, 73 based on the scanner information ‘P002’ and ‘P003’ of the scanner list can execute the reading operation represented by the setting information acquired in S18. Then, it is determined that the scanner apparatus 7, which is specified as a scanner apparatus capable of executing the reading operation by the processing of S24, is not one (S26: YES). That is, it is determined that the scanner apparatus 7 specified as a scanner apparatus capable of executing the reading operation by the processing of S24 is plural number. Then, processing of S28 is executed. In S28, the CPU 21 enables the operation apparatus 3 to acquire the reading-possible apparatus information relating to the plurality of scanner apparatuses 7.

In the specific example, the CPU 21 prepares a second Web page (not shown) and enables the operation apparatus 3 to acquire the same. In the second Web page, a scanner apparatus icon indicating the scanner information ‘P002’ registered in the scanner list and an scanner apparatus icon indicating the scanner information ‘P003’ are displayed in the scanner display area. In S24, it is specified that the scanner information ‘P002’ and ‘P003’ can execute the reading operation represented by the setting information acquired in S18. For this reason, the scanner apparatus icons of the scanner information ‘P002’ and ‘P003’ are under a state where they can be selected by the operation apparatus 3, in response to a user's instruction.

In the meantime, the case where the operation apparatus 3 is enabled to acquire the reading-possible apparatus information relating to the plurality of scanner apparatuses 7 is a case where the user who operates the operation apparatus 3 places the document 89 on the scanner apparatus 7 and another person places the document 89 on another scanner apparatus 7, for example. The user can confirm that there is a plurality of image reading apparatuses on which the document 89 is placed and which can execute the reading operation by the reading setting corresponding to the specification demanded by the external server 10.

In S19, when it is determined that the timeout time period T2 has elapsed (S19: YES), the CPU 21 enables the operation apparatus 3 to acquire timeout information indicating the timeout (S38). The operation apparatus 3 displays the timeout on the display unit 36, based on the timeout information. For example, a message ‘time is up’ is displayed on the display unit 36. In the meantime, when enabling the operation apparatus 3 to acquire the timeout information in S38, a Web page including a message ‘time is up’, for example, is prepared. Then, the CPU 21 enables the operation apparatus 3 to acquire the prepared Web page, in the same manner as the processing of S28. After the processing of S28 is executed, the CPU 21 returns the processing to S11.

In S23, when it is determined that the scanner information is not registered in the scanner list (S23: NO), the CPU 21 enables the operation apparatus 3 to acquire placement request information, which requests placement of the document 89 (S39). In the meantime, when enabling the operation apparatus 3 to acquire the placement request information in S39, a Web page including a message ‘please place a document’, for example, is prepared. Then, the CPU 21 enables the operation apparatus 3 to acquire the prepared Web page, in the same manner as the processing of S28. The operation apparatus 3 displays the Web page on the display unit 36. After the processing of S39 is executed, the CPU 21 returns the processing to S19.

In S25, when there is no scanner apparatus 7 that is specified as a scanner apparatus capable of executing the reading operation by the processing of S24 (s25: YES), the CPU 21 enables the operation apparatus 3 to acquire non-correspondence information. The non-correspondence information represents information indicating that there is no scanner apparatus 7, which can execute the reading operation by the reading setting corresponding to the specification demanded by the external server 10, of the scanner apparatuses 7 on which the document 89 is placed. In the meantime, when enabling the operation apparatus 3 to acquire the non-correspondence information in S40, a Web page including a message ‘it is not possible to execute a reading operation by a reading setting corresponding to a specification demanded by the service’, for example, is prepared. Then, the CPU 21 enables the operation apparatus 3 to acquire the prepared Web page, in the same manner as the processing of S28. The operation apparatus 3 displays the Web page on the display unit 36. After the processing of S40 is executed, the CPU 21 returns the processing to S19 of FIG. 10.

Like this, the main processing of the central server 2 is executed. For example, it is assumed that the documents are placed in order of the scanner apparatus 72 and the scanner apparatus 74 in the list time period T0. In this case, it is specified that the scanner apparatus 72 can execute the reading operation represented by the setting information set in S18 and that the scanner apparatus 74 cannot execute the reading operation represented by the setting information set in S18 (S24). Then, the CPU 21 prepares a third Web page and enables the operation apparatus 3 to acquire the same (S28). An operation-impossible display is displayed around the scanner apparatus icon of the scanner information ‘P004’.

The operation-impossible display is an area that is solidly filled with black or gray, for example. The user of the operation apparatus 3 cannot select the scanner information in the operation-impossible display. That is, the CPU 21 enables the operation apparatus 3 to acquire reading-impossible apparatus information, which indicates that the scanner apparatus 7 based on the scanner information registered in the scanner list is the scanner apparatus 7 incapable of executing the reading operation acquired in S18 (S28). Thereby, the CPU 21 enables the operation apparatus 3 to acquire the specifying result of S24 (S28).

### [7. Operations of Scanner Apparatus 7]

Main processing of the scanner apparatus 7 is described with reference to FIG. 12. The main processing of the scanner apparatus 7 is executed by the CPU 75. The main processing of the scanner apparatus 7 is executed when a power supply becomes on and is over when the power supply becomes off.

It is determined whether the setting information is received or not (S81). The setting information is transmitted from the central server 2 (the arrow 17 of FIG. 2). In the meantime, the setting information received in S81 is the determined transmission information transmitted in S30 of FIG. 11 or setting information transmitted in S31. When the setting information is not received (S83: NO), it is detected whether the document 89 is placed on the scanner apparatus 7 (S82). Then, it is determined whether time T7 is longer than a predetermined time period (S83). The time T7 is measured from 0 in S82 that will be described later. In the meantime, when the processing of S83 of a first time is executed, it is determined that the time T7 is longer than the predetermined time period. The predetermined time period is 15 seconds, for example. When the time T7 is not longer than the predetermined time period (S83: NO), the CPU 75 returns the processing to S81.

When the time T7 is longer than the predetermined time period (S83: YES), the access to the central server 2 is executed (S84). In S84, the scanner information is transmitted to the central server 2. When it is detected in S82 that the document 89 is placed, the status information is transmitted to the central server 2 in S84. The transmitted scanner information and status information are received by the processing of S12 of FIG. 10 or S20 of FIG. 10. In S84, the session information is stored in the session information storage area 763. Thereby, the scanner apparatus 7 maintains the session with the central server 2. Then, the time T7 is measured from ‘0 second’ (S85). Then, the CPU 75 returns the processing to S81.

When the setting information is received (S81: YES), the reading operation is executed with the reading setting based on the received setting information, so that the image data is acquired (S86). Thereby, the document 89 is read with a specification that is demanded by the external server 10, so that the image data is acquired. The acquired image data is stored in the scan data storage area 762. Then, the image data acquired in S86 is transmitted to the central server 2 (S87, the arrow 18 of FIG. 2). That is, the CPU 75 uploads the image data to the central server 2. The transmitted image data is received by the processing of S32 of FIG. 11. Then, the CPU 75 returns the processing to S81. In the meantime, the non-correspondence information that the operation apparatus 3 is enabled to acquire by the CPU 21 in S40 is also an example of the reading-impossible apparatus information.

In the meantime, the disclosure is not limited to the above illustrative embodiment and can be variously changed. For example, the CPU 21 enables the operation apparatus 3 to acquire the reading-possible apparatus information and the reading-impossible apparatus information in S28. However, the CPU may enable the operation apparatus to acquire only one of the information. In S27 and S28, when the automatic scan execution time period T3 elapses, the setting information is automatically transmitted to the scanner apparatus 7. However, the setting information may not be automatically transmitted.

In the scanner display area of the Web page that is prepared in S28, the scanner apparatus icon of the scanner information on which the document 89 is placed is displayed. However, the disclosure is not limited thereto. For example, the scanner apparatus icon of the scanner apparatus 7 on which the document 89 is not placed may be also displayed. In the below, this modified embodiment is described.

In the below descriptions, it is assumed that the document 89 is placed on the scanner apparatus 74 in the list time period T0. In this case, although not shown, the scanner information ‘P004’ is registered in the scanner list (S16 or S21). In S24, the scanner data table 82 is referred to, so that it is specified whether the scanner apparatus 74 based on the scanner information ‘P004’ of the scanner list can execute the reading operation represented by the setting information acquired in S18. In S24 of this modified embodiment, the scanner data table 82 of FIG. 6 is further referred to, so that the scanner information ‘P001’, ‘P002’, ‘P003’ and ‘P004’ corresponding to the access token ‘XXXX’ received in S11 is specified. Then, the scanner apparatus 7, which can execute the reading operation represented by the setting information acquired in S18, is specified from the scanner apparatuses 7 based on the specified scanner information. That is, the scanner apparatuses 71, 72, 73 are specified.

In S28, the operation apparatus 3 is enabled to acquire the specifying result, which indicates whether the scanner apparatus 7 on which the document 89 is placed can execute the reading operation represented by the setting information acquired in S18, and the scanner information, which indicates the scanner apparatus 7 capable of executing the reading operation represented by the setting information acquired in S18. In S28, the CPU 21 prepares a fourth Web page and enables the operation apparatus 3 to acquire the same. Since the scanner apparatus 74 on which the document 89 is placed cannot execute the reading operation represented by the setting information acquired in S18, the operation-impossible display is displayed around the scanner apparatus icon of the scanner information ‘P004’ in the fourth Web page. Since the document 89 is placed on the scanner apparatus 74 of the scanner information ‘P004’, a displacement display, which indicates that the document 89 is placed, is displayed. The placement display is a display including a text of ‘a document is placed’, for example, and is displayed as regards the scanner apparatus icon of the scanner information ‘P004’. Since the scanner apparatuses 71, 72, 73 capable of executing the reading operation represented by the setting information acquired in S18 are specified, the scanner apparatus icons of the scanner information ‘P001’, ‘P002’ and ‘P003’ are also displayed. The scanner apparatus icons of the scanner information ‘P001’, ‘P002’ and ‘P003’ are under a state where they can be selected by the operation apparatus 3, in response to a user's instruction.

Meanwhile, in this modified embodiment, the processing of referring to the scanner data table 82 and specifying the scanner apparatus 7 based on the scanner information acquired in S18, which is added to the processing of S24, may be different from the processing of S24. For example, the processing of referring to the scanner data table 82 and specifying the scanner apparatus 7 based on the scanner information acquired in S18 may be executed after the processing of S18.

What is claimed is:

1. A system comprising:
an information processing apparatus; and
an image reading apparatus,
wherein the information processing apparatus comprises:
a first processor; and
first memory storing computer readable instructions, when executed by the first processing, cause the information processing apparatus to:
store, in a memory:
service identification information for identifying a service providing apparatus;
setting information representing a specification of a reading setting of an image reading apparatus for the service providing apparatus, in association with the service identification information;
user identification information;
a plurality of apparatus identification information for identifying a plurality of image reading apparatuses in association with the user identification information; and
a plurality of function information in association with each of the plurality of apparatus identification information, each of the plurality of the function information representing a function represents each of the image reading apparatuses can execute the reading operation;
receive, from an operation apparatus, a reading instruction for instructing an image reading apparatus to execute a reading operation, specific service identification information, and specific user identification information;
acquire the setting information associated with the specific service identification information from the memory;
determine whether one or more of status information including specific apparatus identification information are received during a first time period around the time of receiving the reading instruction;
store, in a memory, the one or more of specific apparatus identification information, in response to determining that one or more of status information are received during the first time period;
determine whether one or more of specific image reading apparatuses identified by the one or more of specific apparatus identification information can execute the reading operation represented by the acquired setting information, using one or more of the plurality of function information associated with the one or more of specific apparatus identification information; and
transmit a determination result to the operation apparatus based on determining whether the one or more of specific image reading apparatuses can execute the reading operation, and
wherein the image reading apparatus comprises:
a second processor; and
second memory storing computer readable instructions, when executed by the second processor, cause the image reading apparatus to:
determine whether a reading target is placed on the image reading apparatuses; and
transmit the status information to the information processing apparatus.

2. An information processing apparatus comprising:
a processor; and
memory storing computer readable instructions, when executed by the processor, cause the information processing apparatus to:
store, in a memory:
service identification information for identifying a service providing apparatus;
setting information representing a specification of a reading setting of an image reading apparatus for the service providing apparatus, in association with the service identification information;
user identification information;
a plurality of apparatus identification information for identifying a plurality of image reading apparatuses in association with the user identification information; and
a plurality of function information in association with each of the plurality of apparatus identification information, each of the plurality of the function information representing a function represents each of the image reading apparatuses can execute the reading operation;
receive, from an operation apparatus, a reading instruction for instructing an image reading apparatus to execute a reading operation, specific service identification information, and specific user identification information;
acquire the setting information associated with the specific service identification information from the memory;
determine whether one or more of status information including specific apparatus identification information are received during a first time period around the time of receiving the reading instruction, the status information representing a reading target is placed on an image reading apparatuses identified the specific apparatus identification information;
store, in a memory, the one or more of specific apparatus identification information, in response to determining that one or more of status information are received during the first time period;
determine whether one or more of specific image reading apparatuses identified by the one or more of specific apparatus identification information can execute the reading operation represented by the acquired setting information, using one or more of the plurality of function information associated with the one or more of specific apparatus identification information; and
transmit a determination result to the operation apparatus based on determining whether the one or more of specific image reading apparatuses can execute the reading operation.

3. The information processing apparatus according to claim 2,
wherein the determining whether the one or more of status information are received during the first time period comprises determining whether the one or more of the status information are received within the first time period after the time of receiving the reading instruction.

4. The information processing apparatus according to claim 2,
wherein the transmitting the determination result to the operation apparatus comprises transmitting reading-possible apparatus information representing the one or more of specific image reading apparatuses identified by the one or more of specific apparatus identification information can execute the reading operation, in response to determining that the one or more of specific image reading apparatuses identified by the one or more of specific apparatus identification information can execute the reading operation.

5. The information processing apparatus according to claim 4,
wherein the computer readable instructions, when executed by the processor, further cause the information processing apparatus to:
determine whether a number of image reading apparatuses which can execute the reading operation represented by the acquired setting information is plural number, in response to determining that the one or more specific image reading apparatus identified by the one or more of specific apparatus identification information can execute the reading operation, and
wherein the transmitting the reading-possible apparatus information comprising transmitting a plurality of the reading-possible apparatus information corresponding to the plural number of the image reading apparatuses, in response to determining that a number of image reading apparatuses which can execute the reading operation represented by the acquired setting information is plural number.

6. The information processing apparatus according to claim 2,
wherein the transmitting the determination result to the operation apparatus comprises transmitting reading-impossible apparatus information representing the one or more of specific image reading apparatus identified by the one or more of specific apparatus identification information cannot execute the reading operation, in response to determining that the one or more of specific image reading apparatuses identified by the one or more of specific apparatus identification information cannot execute the reading operation.

7. The information processing apparatus according to claim 2,
wherein the computer readable instructions, when executed by the processor, further cause the information processing apparatus to:
determine whether a number of an image reading apparatus which can execute the reading operation represented by the acquired setting information is one, in response to determining that the one or more specific image reading apparatus identified by the one or more of specific apparatus identification information can execute the reading operation; and
transmit the acquired setting information to the determined image reading apparatus after a pre-determined time period elapses, in response to determining that a number of an image reading apparatus which can execute the reading operation represented by the acquired setting information is one.

8. The information processing apparatus according to claim 2,
wherein the computer readable instructions, when executed by the processor, cause the information processing apparatus to:
identify one or more of apparatus identification information corresponding to the one or more specific image reading apparatuses, in response to determining that one or more specific image reading apparatuses identified by the one or more of specific apparatus identification information can execute the reading operation, and
wherein the transmitting the determination result comprises transmitting the identified one or more of apparatus identification information to the operation apparatus.

9. A non-transitory computer-readable medium storing computer-readable instructions that, when executed by a processor, cause an information processing apparatus to:
store, in a memory:
service identification information for identifying a service providing apparatus;
setting information representing a specification of a reading setting of an image reading apparatus for the service providing apparatus, in association with the service identification information;
user identification information;
a plurality of apparatus identification information for identifying a plurality of image reading apparatuses in association with the user identification information; and
a plurality of function information in association with each of the plurality of apparatus identification information, each of the plurality of the function information representing a function represents each of the image reading apparatuses can execute the reading operation;
receive, from an operation apparatus, a reading instruction for instructing an image reading apparatus to execute a reading operation, specific service identification information, and specific user identification information;
acquire the setting information associated with the specific service identification information from the memory;
determine whether one or more of status information including specific apparatus identification information are received during a first time period around the time of receiving the reading instruction, the status information representing a reading target is placed on an image reading apparatuses identified the specific apparatus identification information;
store, in a memory, the one or more of specific apparatus identification information, in response to determining that one or more of status information are received during the first time period;
determine whether one or more of specific image reading apparatuses identified by the one or more of specific apparatus identification information can execute the reading operation represented by the acquired setting information, using one or more of the plurality of function information associated with the one or more of specific apparatus identification information; and
transmit a determination result to the operation apparatus based on determining whether the one or more of specific image reading apparatuses can execute the reading operation.

10. The non-transitory computer-readable medium according to claim 9,
wherein determining whether the one or more of status information are received during the first time period comprising determining whether the one or more of the status information are received within the first time period after the time of receiving the reading instruction.

11. The non-transitory computer-readable medium according to claim 9,
wherein transmitting the determination result to the operation apparatus comprising transmitting reading-possible apparatus information representing the one or more of specific image reading apparatuses identified by the one or more of specific apparatus identification information can execute the reading operation, in response to determining that the one or more of specific image reading apparatuses identified by the one or more of specific apparatus identification information can execute the reading operation.

12. The non-transitory computer-readable medium according to claim 11,
wherein the computer readable instructions, when executed by the processor, further cause the information processing apparatus to:
determine whether a number of image reading apparatuses which can execute the reading operation represented by the acquired setting information is plural number, in response to determining that the one or more specific image reading apparatus identified by the one or more of specific apparatus identification information can execute the reading operation, and
wherein the transmitting the reading-possible apparatus information comprises transmitting a plurality of the reading-possible apparatus information corresponding to the plural number of the image reading apparatuses, in response to determining that a number of image reading apparatuses which can execute the reading operation represented by the acquired setting information is plural number.

13. The non-transitory computer-readable medium according to claim 9,
wherein the transmitting the determination result to the operation apparatus comprises transmitting reading-impossible apparatus information representing the one or more of specific image reading apparatus identified by the one or more of specific apparatus identification information cannot execute the reading operation, in response to determining that the one or more of specific image reading apparatuses identified by the one or more of specific apparatus identification information cannot execute the reading operation.

14. The non-transitory computer-readable medium according to claim 9,
wherein the computer readable instructions, when executed by the processor, further cause the information processing apparatus to:
determine whether a number of an image reading apparatus which can execute the reading operation represented by the acquired setting information is one, in response to determining that the one or more specific image reading apparatus identified by the one or more of specific apparatus identification information can execute the reading operation; and
transmit the acquired setting information to the determined image reading apparatus after a pre-determined time period elapses, in response to determining that a number of an image reading apparatus which can execute the reading operation represented by the acquired setting information is one.

15. The non-transitory computer-readable medium according to claim 9,
wherein the computer readable instructions, when executed by the processor, cause the information processing apparatus to:
identify one or more of apparatus identification information corresponding to the one or more specific image reading apparatuses, in response to determining that one or more specific image reading apparatuses identified by the one or more of specific apparatus identification information can execute the reading operation, and
wherein the transmitting the determination result comprises transmitting the identified one or more of apparatus identification information to the operation apparatus.
